(19) United States
(12) Patent Application Publication
(10) Pub. No.: US 2017/0198880 A1
(43) Pub. Date: Jul. 13, 2017

(54) Method and means for increasing energy efficiency of LED luminaries

(71) Applicant: Sergio Lara Pereira Monteiro, Los Angeles, CA (US)

(72) Inventor: Sergio Lara Pereira Monteiro, Los Angeles, CA (US)

(21) Appl. No.: 15/470,444

(22) Filed: Mar. 27, 2017

Related U.S. Application Data
(63) Continuation-in-part of application No. 14/937,874, filed on Nov. 11, 2015.

(51) Int. Cl. F21V 7/00; F21V 21/04; F21V 23/06; F21V 11/06; F21S 8/02

(52) U.S. Cl. CPC F21V 7/0008; F21V 11/06; F21S 8/026; F21V 23/06; F21V 21/048

(57) ABSTRACT

We disclose a hardware supporting structure that we call drop box, designed to keep LED light emitters in fixed position in space while emitting light toward the higher parts of the walls around a room and to the ceiling above the room. Our invention assumes that the walls and the ceiling are good reflectors, painted with such pigments as to reflect 90% of the light (typical value), which is the case for most rooms, and which is a limiting factor for our invention. The position and direction of the LEDs of our invention, illuminating the upper part of the walls and the ceiling, is such that there is no need for the frosty material covering most existing luminaries. Because the frosty enclosures only transmit 75% of the light that propagates through them (typical value), our invention improves on the energy efficiency of the luminaries.

### CROSS-REFERENCE TO RELATED APPLICATIONS

This utility patent application is a continuation-in-part application to U.S. patent application Ser. No. 14/937,874, filing date 2015 Nov. 11, entitled “Method and means to evenly distribute ambient illumination and to avoid bright LED beam directly into human eyes”.

This utility patent application claims the benefit of provisional patent application No. 62/443,285, filing date 2017 Jan. 6, titled “Several variations of method and means for isotropic evenly distributed ambient illumination and to avoid bright LED beam directly into human eyes” and of provisional patent application No. 62/313,772, filing date 2016 Mar. 27, titled “Second variation of method and means for isotropic evenly distributed ambient illumination and to avoid bright LED beam directly into human eyes”, both from the same inventor, the benefits of which are claimed according to the law and incorporated in this patent application.

### FEDERALLY SPONSORED RESEARCH

Not applicable

### SEQUENCE LISTING OR PROGRAM

Not applicable

### BACKGROUND OF THE INVENTION

Field of Invention

This invention relates to devices that increase the energy efficiency of luminaries for domestic, commercial, industrial and outdoor uses.

### BACKGROUND

Discussion of Prior Art

We start this section with the definition of the most important terms we use, in order to comply with the USPTO requirement of the use of “exact terms” and also for not to leave room for misunderstandings of the meaning of our words as used in this document. Firstly here we specify some key terms we use, then some of the abbreviations used in the figures, with their precise definition too.

Diffuse reflection also known as non-specular reflection is the reflection on a surface such that incident light is reflected to all directions, though not necessarily isotropically. Most white walls are diffuse reflectors. Also, for our use here, the definition generally does not imply perfect diffusiveness, but is acceptable when the reflection is “more-or-less” diffuse, that is, when there is preferential reflection towards some angles, as long as this anisotropy is small. cf. with specular reflection. Often diffuse reflectors are characterized by a rough surface with a surface roughness that is very small for the characteristic dimensions of the situation (see FIG. 1)

Divergence angle—when applied to a directed light emitting device, divergence angle measures the angle which encompass the majority of the photons emitted by the source. Following general practice, we here use “majority of” meaning 1/e=˜1/2.7182818=˜0.36788=approx 37% of the total light energy emitted within a cone with apex angle equal to the divergence angle, with the light source at the apex.

drop-box (aka LED-box): Our term, not used before, for a box of our invention, which attaches to the ceiling or to the faux-ceiling, which supports a plurality of LEDs capable of emitting light on a horizontal direction (or just off-horizontal direction), generally toward the upper part of the walls and/or the ceiling, from where the light undergoes diffuse reflection, causing an indirect illumination.

E26-E27 There is a lot of confusion about the use of these names, and no agreement on their meaning. Therefore we here define only our meaning of the words used according to the best we could have determined to be the use by most people. E26 is the technical name of the American standard household incandescent light bulb socket, which seems to mean 26 mm, which is said to be 1 inch. In reality 1 inch is 2.54 mm, which would be approximated to 2.5 mm not to 2.6 mm. We do not know the history, etc of this. It appears that E26 is the standard adopted in US, Canada, Central and South America (excluding Brazil), Japan and Taiwan. E27 is the similar standard used in Europe and most of the world, and it seems that it stands for 27 mm. These bulbs are more-or-less interchangeable, because the difference is small, there are a few threads only, and they are made with large tolerance. We will be using the name E27 because it is the standard adopted in most of the world, while it will be understood that what is stated for E27 applies equally well to E26. It appears that E stands for Edison (Thomas Alva Edison). (cf. Edison screw)

Edison screw. Name of the mechanical/electrical standard for the screw base used for the common incandescent light bulb which is the almost universal light producing device in US. Europe uses an almost equal size, with same pitch but 1 mm wider. (cf. E26-E27)

Electromagnetic wave. Any of the oscillations of an electric field and a magnetic field described by Maxwell's equations, which include as a special case the visible light but also many other types, as gamma rays, ultraviolet light, infrared light, microwave, radio waves and more.

Faux-ceiling. Expression using the French term for false (faux (Fr)=false (Engl))This is generally used as a dropped ceiling, below the real ceiling, often made from a horizontal truss, on which rectangular thin and light weight, usually white colored, usually artificial material cut into rectangular shapes are laid. Most commonly used in businesses and schools, hardly used in homes or in expensive offices.

Illuminance is defined as the total luminous flux (q.v.) incident on a surface, per unit area. It therefore measures the amount of incident light that illuminates the surface corrected by the luminosity function that measures the physiological perception of light as detected by the human light detectors (cones and rods). By “corrected” we mean that light of longer wavelengths, say, λ=690 nm, a deep red, near the edge of detection by human eyes, is detected with an 8% relative efficiency (relative here means compared with the efficiency of the detection system of a human at the green λ=555 nm, which it the maximum efficiency for humans) then the electromagnetic energy at this wavelength is multiplied by 0.08 (8%) to account for this small efficiency of detection at its wavelength. The limiting case of the correction is the case of electromagnetic waves outside the visible window, say, infrared and ultraviolet, in which case the multiplying factor is 0 (zero), because these electromagnetic waves are not detected by the human eye. The correction is applied at the luminous flux step. (cf. luminance and luminous flux).

Incandescent light bulb: This is the almost universal light source used in homes, also much in use in business and schools. It uses a connector known as E26 in the United States and a few other countries, and E27 in Europe and most of the world. The number refer to 26 mm and 27 mm, and 26 mm supposedly is 1 inch, which it is not. Due to the large tolerance used in their manufacture, they are usually interchangeable, but occasionally one meets an European E27 that does not enter in a smaller American E26.

Jumper: an electrical connector that wraps a piece of metal around two wires, therefore completing the electrical connection between the two wires. Jumpers are common in digital electronics, and the most common situation which a non-technical person encounter jumpers is their use to select which is the use of the older PATA hard drives, either master, or slave. In digital electronics the jumpers are used to connect/disconnect a particular point to ground (or to the positive supply, whichever is the voltage for the circuit), therefore making the particular point low (high) in the language of digital electronics, which is then interpreted by digital logic to implement one of two choices (binary choices, including address and/or control).

LED. Abbreviation of Light Emitting Diode. The name is misleading because there are LEDs that emit in other regions of the electromagnetic spectrum beyond the visible, as the ultraviolet and infrared. When we use the term LED we mean the general use of the term, meaning any wavelength produced by LEDs, visible and beyond, and when we refer to LED light we are also simply using the established practice of using light as a synonym of any electromagnetic radiation produced by the LED. This is a common practice, also used in LASERs, which is an abbreviation of Light Amplification by Stimulated Emission of Radiation, but there are LASERs emitting radiation from the X-ray, through the ultraviolet, the visible, the infrared to the micro-wave parts of the electromagnetic spectrum.

LED-box (aka drop-box): Our term, not used before, for a box of our invention, which attaches to the ceiling or to the faux-ceiling, which supports a plurality of LEDs capable of emitting light on a horizontal direction (or just off-horizontal direction), generally toward the upper part of the walls and/or the ceiling, from where the light undergoes diffuse reflection, causing an indirect illumination.

LED chips Light Emitting Diode chip, is the name of our creation for the small, typically 2 mm by 2 mm elements that emit light. The chips can be easily seen in most of the clear window LED emitters. These are not chips in the standard use of integrated circuits, but only in the sense of being semiconductor devices (diodes). The name is misleading, because there are LEDs emitting ultra-violet and infra-red electromagnetic radiation, so light in the name should be understood as electromagnetic radiation instead of visible light. a left-over from the initial LEDs, when they were only capable of producing visible light The 2 by 2 mm2 is just typical dimension, the actual size of any particular one may be different.

Louver is a (generally small) protrusion used for controlling the light propagation, generally to block light propagation along some direction or directions. Louvers are mostly used in our invention to block light propagation below a critical angle with the horizontal, which would otherwise hit the eyes of humans in the environment, but some applications of our invention use louvers in other directions and situations too.

Luminance of a light emitting surface is defined as the quantity of visible light emitted per unit of surface area of the emitting surface, along a specific direction, as detected by an average H. sapiens. This last proviso means that the luminance value is weighted by the relative or perceived brightness to a person. It is measured in candela per square meters (cd/m**2). It therefore measures the amount of emitted visible light from a specific projected area that propagates along a specific direction. (cf. illuminance and luminous flux)

Luminous flux (also known as luminous power, which is a more intuitive name but which I will not use here because it is less used than luminous flux) is defined as the measure of the perceived power of light as detected by an average fictitious human being. We are here using power in its scientific meaning of energy per unit time. In practical terms this means that the actual electromagnetic energy is multiplied by a factor that measures the relative sensitivity of the human eyes detectors for each wavelength (color) of light. This factor is 1 (one) at the maximum efficiency of the human eye near the green (λ=555 nm, but there is a difference between the photopic and scotopic cases which we leave aside here), decreasing to 0 (zero) at the borders with the infrared and ultra-violet, both of which are invisible to human eyes. Note that even at the maximum efficiency not all photons are detected by the human rods and cones, and the factor is 1 only because it is a relative (not absolute) correction factor. (cf. illuminance and luminance)

Normal incidence: is defined in optics and geometry as perpendicular incidence. In optics normal is defined as perpendicular to a surface or to a line. By convention, all angles in optics are measured from the normal, so normal incidence in optics is 0 dgs. (zero degrees).

Shade vs. shadow. These two terms will be used in the text and we use them in the standard way. We define them here not because we are using these words in any unusual way, but only because they are similar yet their place in the understanding of our invention is crucial. For us here “shade” means the cover (the physical object) often used around some light sources, which scatters the light source inside, causing that the full (larger) surface of the shade becomes the origin of the light for the external part of it. Our use of the word “shade” is the physical object often made from thin fabric or paper or frosty glass that often surrounds a lamp inside. “Shadow” means a region of smaller illumination then the surrounding regions, particularly if with a sharp transition in illuminance which results from an opaque object blocking light from reaching the area of the shadow.

Specular reflection is the reflection on a surface such that light incident on the surface at a particular angle θi with the normal is reflected at the angle θr which is equal to θi, but towards the opposite side of the normal. Mirrors are specular reflectors. (see FIG. 1) (cf. Diffuse reflection).

Some of the abbreviations used in the figures:

hem1=stands for hemsphere1, the shape of the main LED chip supporting surface. We will use the term in a more generalized way, even if the supporting surface is not a true hemisphere, so, in the context of this patent disclosure hem1 stands for the structure that supports the LED chips.

supp1=stands for support1, the main supporting structure that also makes all the required electrical connections. There are several possible forms of supp1, each corresponding to one of the existing mechanical/electrical standards. Examples of supp1 are the Edison-screw (E26 and E27) standards for the incandescent bulbs used for home light in US, the long fluorescent tubular used mostly in offices, educational institutions and businesses, the smaller halogen bulbs much in use in Europe, etc.

A quick look at some pre-LED light devices, either with the eyes or with the memory, shows that associated with their different characteristics there comes different physical supports, different electrical characteristics, and even different safety mechanisms. The most used light source in homes was the incandescent electric bulb, which produced a mostly isotropic light emanating from a small volume—the filament. One of the light sources most used in businesses was the tubular fluorescent light, which for business purposes was a long tube some 2, 4 or more feet long, which produced also a mostly isotropic light, but from a much larger source, which is the whole surface of the long glass tube. From the point of view of their use, one major difference is that the light produced by the incandescent light bulb is too strong to be looked at directly, while the light produced by the fluorescent lamps is not bright enough to be annoying. It follows that the former, the light bulb, typically has some or several devices to decrease the luminous flux (the brightness in normal language), while the latter, the long fluorescent lamps, do not need them as much. Such characteristics turn out to be important for our invention, because our invention is a correction to some of the implementation of the LED light sources that have been introduced to replace the old, less efficient sources, as the light bulb (the least efficient of all), the fluorescent sticks (a little more efficient than the light bulb), and etc. We will be reviewing some of this in the sequel, but want to open the reader to the fact that the physical characteristics of LED replacement need not be too similar to the physical characteristics of the older, less efficient types of luminaries, because the characteristics of the light produced is different. In fact, there are some characteristics of the LED replacements that should be different than the older style to adapt for some of the new characteristic of the LEDs. Some of the physical characteristics needs to stay the same, insofar they are part of the necessary characteristics to make the LED replacement compatible with the old standard, but adaptations need to be made, this being the object of our invention: modifications of the characteristics of the old physical standards to make the LED replacement more suitable to the new use.

Electric light has been dominated by incandescent bulbs for almost a century, with a smaller niche of fluorescent lights used most by businesses, then some halogens, and a few other types. The former, incandescent bulbs, established a de facto standard for home use, to which all new technology must adhere to in order to be adopted, particularly for the size and mechanical attaching system and electrical connections, which provides both physical stability and electrical contact. Most home luminaries use the E27/E26 incandescent filament bulb, which is the least energy efficient luminary. It is usually made from tungsten, which is inside an evacuated glass enclosure. The vacuum is needed to prevent oxidation of the filament, which has to be heated to as high a temperature as technologically feasible, which is in the neighborhood of 2,700K=3000 C, because the efficiency of light output increases with increasing temperature. This in turn determined the choice for the filament, which is virtually always tungsten (W) because if its high melting point, in spite of its rarity on surface of our planet. These old tungsten filament bulbs, aside their energetic inefficiency, produce light on an almost 4*π stereoradians (that is on an almost spherical volume that surrounds them). One of the characteristics of the light bulb is that the light emanates from a “small” volume (small is a relative concept here). A second characteristic of it is that the light emanates mostly

A later device was the fluorescent light, which also emitted light on a 4*π stereoradians. Halogen bulbs, on the other hand, generally come associated with a back reflector, causing that they act almost as a headlight, or a forward-directed, small divergence light source—most of them, not all of them.

The tubular fluorescent lamps or light sources are generally used in schools, business and industrial facilities. Many of the tubular fluorescents lamps are placed above a faux-ceiling. This faux-ceiling is usually a white light weight material, most often white color to increase the reflectivity, often with randomly positioned small holes on its surface, which is kept in place supported by a light truss-like structure. Inside the hole there exist electrical connectors for a few tubular fluorescent lamps, most often 3 to 5 of them, but occasionally less or more. The space or hole on the faux-ceiling is often covered by a plastic sheet, which virtually always are a continuation of the faux-ceiling, that is, the plastic sheet is part of the planar surface defined by the faux-ceiling. The plastic cover sheet has the function of scattering the light coming from the tubular fluorescents above them, in order to decrease the luminous flux (more of less brightness in common language). The plastic cover sheet causes energy inefficiency because besides the intended consequence of scattering the light that propagates through it, the cover sheet also absorbs light, typically of the order of 25% or more, which is a non-negligible amount. Our invention is a method and a means to avoid the use of this scattering plastic cover below the tubular fluorescents inside the hole in the faux-ceiling.

One of the consequences of this 4*π or all-around emission, is the accessory devices that are associated with their use, which are so ubiquitous as to appear necessary, obvious, and normal to all of us—even when they happen to be neither of these: not necessary, not obvious and not normal. One of these accessories is the ubiquitous light scattering elements that usually surrounds the filament-style tungsten light bulbs, as the milky-looking hemisphere that surrounds most ceiling lamp fixtures designed to accept incandescent bulbs, the milky-looking and also faceted plastic surfaces, flat, easily cut, which covers many of the long fluorescent light fixtures at the ceiling in business and offices, the more-or-less cylindrical enclosures, usually known as shades, that exist around most lamps at the human space level, designed to prevent the horizontal fraction of the light emitted by the incandescents to go directly to the eyes of humans in the environment, while allowing light to escape unhindered upward to the ceiling and downward to the floor, and other devices adapted to each situation which prevent the stronger light to be directed towards the human eye.

All these light-scattering devices were desirable because the dominant light emitters used until very recently produced light along all directions around them, and consequently would be too bright for humans to look directly at them. Conversely, they would not be necessary and would not have been introduced if the light sources were less bright. The truth of this can be seen by the lack of shades or any other scattering device associated with the halogen lamps.

### OBJECTS AND ADVANTAGES

Accordingly, one of the objects of our invention is to introduce modifications on the supporting structure of the old physical model that is adapted for the LED (light bulb, fluorescent lamp sticks, etc.), so that the LED driven light sources take full advantages of the characteristics of the LEDs for the new use within the older supporting structure.

Other objects and advantages of my invention are making unnecessary the light-scattering/light distributing devices around the light bulbs and fluorescent lights of the past and still in use.

Other objects are to decrease the cost of light fixtures obviating the need of the scattering screens around the light bulbs and fluorescent lights of the past,

Other object is to further increase the energy efficiency of the modern LED lighting devices, particularly the ones designed to substitute old tubular fluorescent or the E26/E27 incandescent devices, because the scattering covers used with them also absorb, so their elimination increases the light intensity available for the object of illuminating the space.

If one or more of the cited objectives is not achieved in a particular case, any one of the remaining objectives should be considered enough for the patent disclosure to stand, as these objectives are independent of each other.

### SUMMARY OF THE INVENTION

The invention discloses a method and means to direct the light emitted by currently used LED light sources into such directions as to obviate the need of light scatterers surrounding the light sources. The LED light sources that are currently manufactured typically have a plurality of relatively small LED light emitters distributed on part of the surface of the supporting structure (see FIG. 2), which may emit light along a certain direction only, or along all directions (omnidirection, perhaps isotropic too). The invention also discloses a method and a means to enable/disable some of the individual light emitters out of the plurality of light emitters of the LED sources of our invention with the objective of precluding light emission along certain directions—and allowing light emission along other directions, to achieve the ultimate objective of an isotropically distributed light that does not emit strong light into the eyes of any human being in the neighborhood.

### BRIEF DESCRIPTION OF THE DRAWINGS

FIG. 1. Specular and diffuse reflections.

FIG. 2. Old art—corn-style LED substitute for E26/E27 incandescent bulb. LEDs facing the viewer omitted for clarity.

FIG. 3. Exploded view of drop box of our invention: hole above faux-ceiling, where the upper part of our invention is inserted, the actual drop box in perspective, then at the lower part the drop box with an optional louver at the bottom of the drop box it.

FIG. 4. Drop box of our invention, with hole above faux-ceiling above it and louver below it, no LEDs at bottom for clarity.

FIG. 5. Hole above faux-ceiling showing electrical socket contacts for tubular fluorescents of old art.

FIG. 6. Drop box of our invention showing hole above and light rays propagating to the right toward ceiling and wall, also showing louver reflecting light, view from longer dimension.

FIG. 7. Drop box of our invention. Note louver with two surfaces and no louver shown on frontal surface for clarity.

FIG. 8. Drop box of our invention showing socket electrical contacts for tubular fluorescents of old art. Note louver with two surfaces and no louver shown on frontal surface for clarity.

FIG. 9A. Drop box of our invention, longer dimension, or side view.

FIG. 9B. Drop box of our invention, shorter dimension, of end view.

FIG. 10. The reader will see that a single louver (Louver2) at the bottom of the luminary has to protrude further out of the luminary than louvers just next to each LED chip (Louver1) if it is intended to catch the same “light rays”, say, at 30 degrees angular aperture as shown.

FIG. 11. Wedge to be inserted between any two LED group, in this case one group to the left of the wedge, the other group to the right of the wedge, the function of which is to cause a downward scattering of the light while forestalling a direct light onto the next LED with possible absorption. The upper, longer side is attached to the ceiling, with LEDs at the sides of the boxes of the invention pointing from the right (to left) and from the left (to right) of the wedge of the invention. Angle a is small, just enough that the lower part of the wedge is low enough that light from the light box of the invention situated at the right of the wedge cannot illuminate the light box of the invention situated at the left of the wedge.

FIG. 12. Drop box of our invention with alternative position for LEDs at the top left box.

FIG. 13. Different possible louver shapes. Many more are possible.

FIG. 14. Fresnel equations.

FIG. 15. Graph of Fresnel equations from 0 to 90 degrees incidence angle.

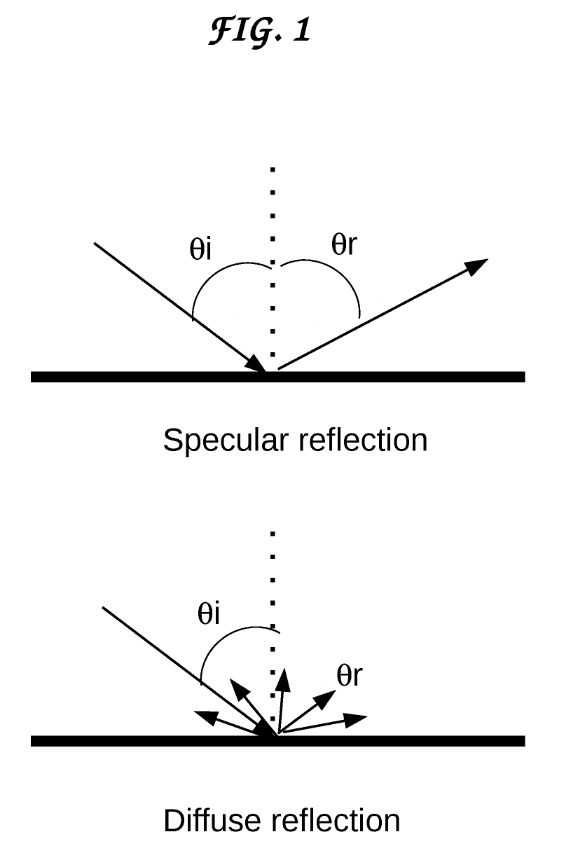

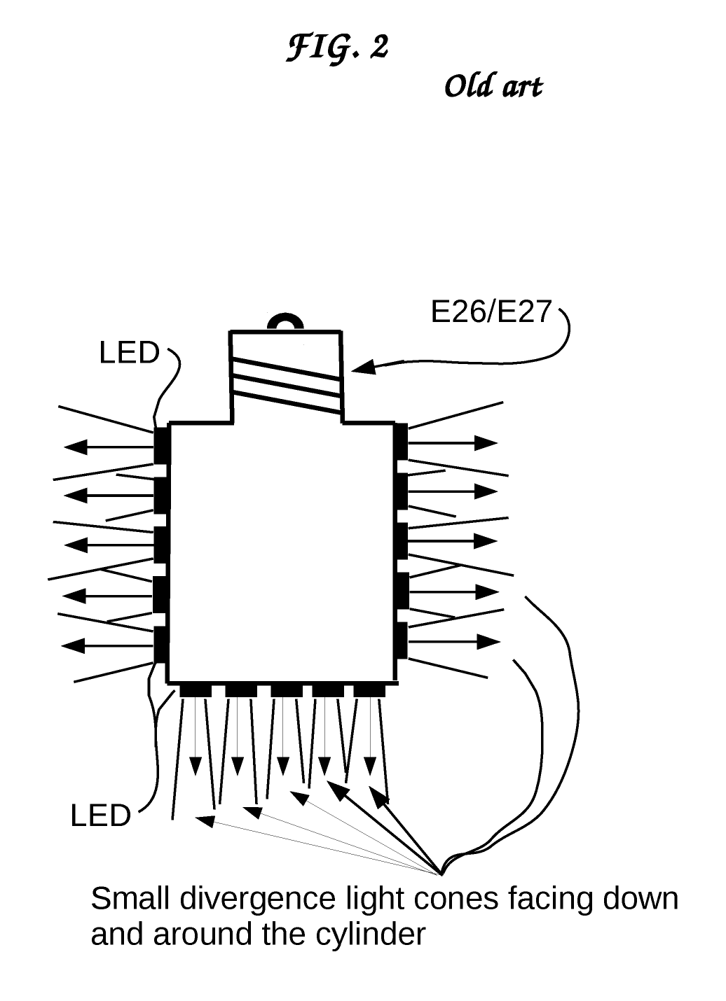

### DRAWINGS—LIST OF REFERENCE NUMERALS

d1, d2, d3=several light rays.

E26/E27=Edison 26/Edison 27, US/European names for the standard screw size used by old art incandescent bulbs.

n1 and n2=index of refractions for medium 1 and medium 2.

Rs=reflectance for s-polarized wave.

Rp=reflectance for p-polarized wave.

α=angle of wedge.

θi=angle of incidence.

θr=angle of reflectance.

### DETAILED DESCRIPTION

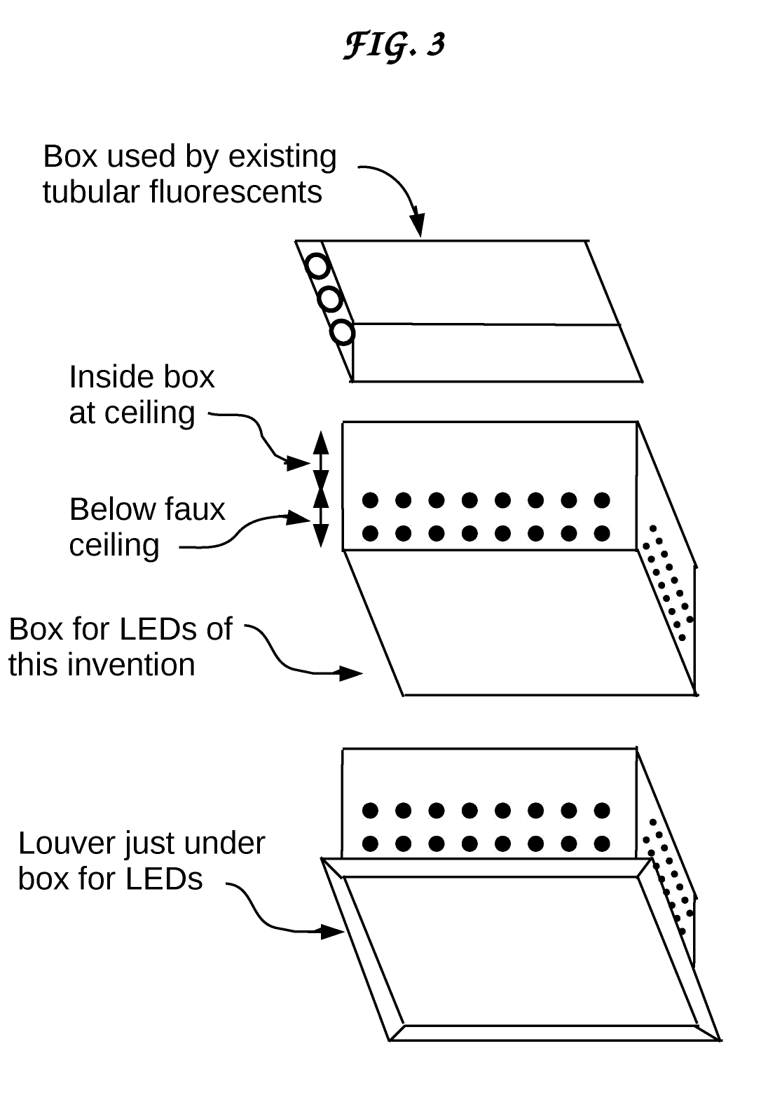

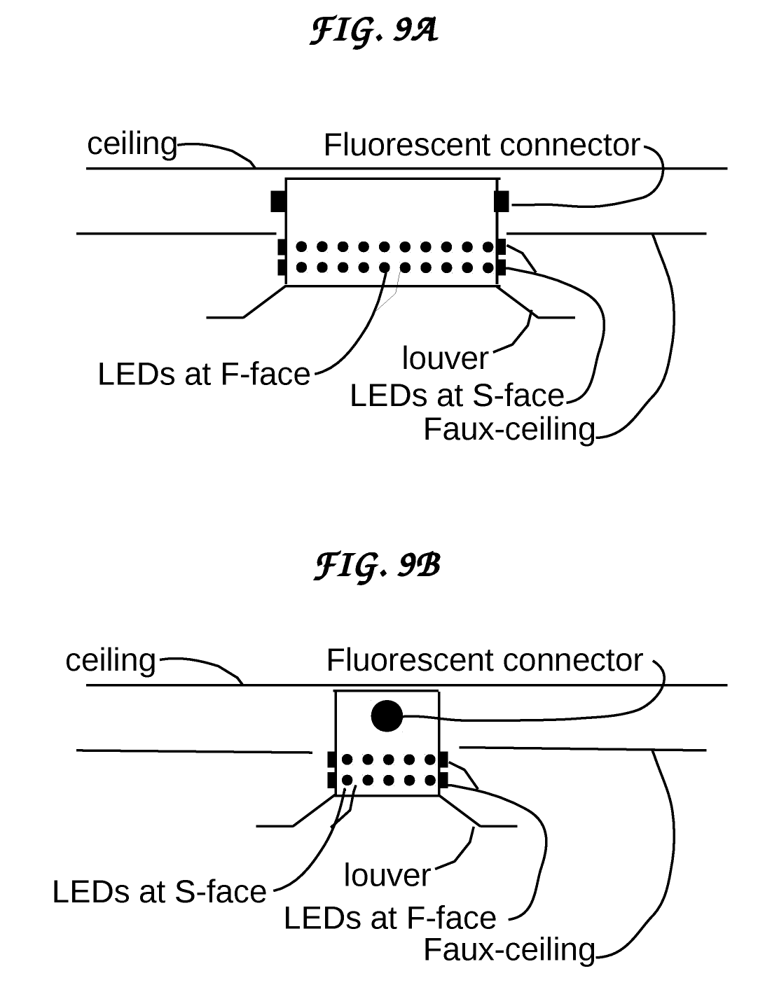

FIGS. 3, 4, 5, 6, 7, 8, and 9 show several views and aspects of the main embodiment of our invention, which we call fluorescent drop box because our invention discloses a box that fits snugly into the hole into the faux-ceiling for the tubular fluorescent lamps. The drop box of our invention sports LED luminaries below the faux-ceiling, as opposed to above it, as was done previously (prior art in attorney's lingo), in the process obviating the need of the scattering plastic sheets that absorb 25% and more of the light energy produced by the tubular fluorescent lamps of old technology above them.

FIGS. 3 through 9 show side views, one perspective view and an one exploded view of our invention and complement each other. As is explained in the sequel, our invention is a modification on the LED illumination devices which are designed to accommodate the standards used by the former technologies, as light bulbs, fluorescent lights, etc. Our invention is applicable for all the old illumination technologies (old art in patent parlance), and we will describe it for a device adapted for use with tubular fluorescent lamps that are located inside a hole on a faux-ceiling. Modifications for other technologies will be obvious to persons that work in the field, some of which is described below. As seen in the FIGS. 3, 4, 5, 6, 7, 8, and 9, mentioned above, our invention disclose a hardware with an upper part and a lower part, also called upper supporting structure and lower supporting structure to highlight the fact that the upper part is a supporting structure for the lower part and that the lower part is a supporting structure for the LED light emitters. The upper part of the device is, for the main embodiment, a supporting structure inserted in a hole above a faux ceiling, as a mesh frame, a frame in the shape of a parallelepiped, a box made from metal or other material, or any other structure capable of being physically attached to the structure of the building, also with electrical connections to the building power supply, and providing mechanical and electrical connection to the lower part. The lower part of the device, for the main embodiment, is a box physically kept in place by the upper part, from which the lower part also receives electrical wires with the necessary electrical connectors to the building power wires, having mechanical and electrical connections where to attach LEDs designed for illumination. The upper part of the hardware for the main embodiment has hardware to attach the device in a fixed position with respect to the room, and also hardware to provide electrical connection to the electrical power system used in the building, which is capable of powering the illumination LEDs located at the lower part. The lower part of the hardware is kept in place by the upper part, from which the lower part also receives electrical power, and has connectors designed to receive and keep in fixed position a plurality of LEDs that are so oriented in position and orientation in space as to direct light to the upper part of the walls and to the ceiling of the room. In most cases the lower part has a surface that is either a curved surface or a plurality of rectangular or differently shaped sides such that the normal (perpendicular) to the surfaces are either horizontal lines or lines that deviate from the horizontal direction by a small angle, say, by less than 30 degrees. As seen at FIG. 3, which is an exploded view of our invention, the drop box of our invention is the box shown at the middle of the figure, with an upper part that is inserted in the hole above the faux-ceiling (above it), and a lower part where a plurality of LEDs are attached, as depicted. At the bottom the reader can see a repetition of the drop box of our invention with an optional louver at the bottom of it.

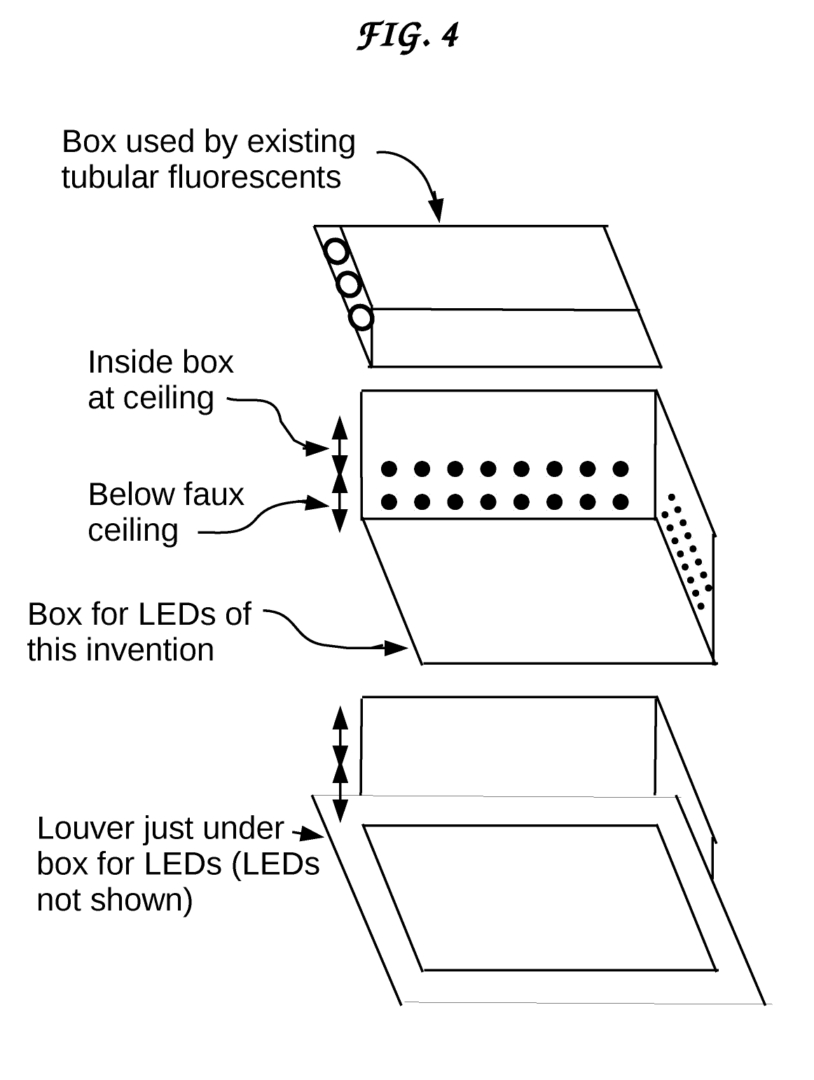

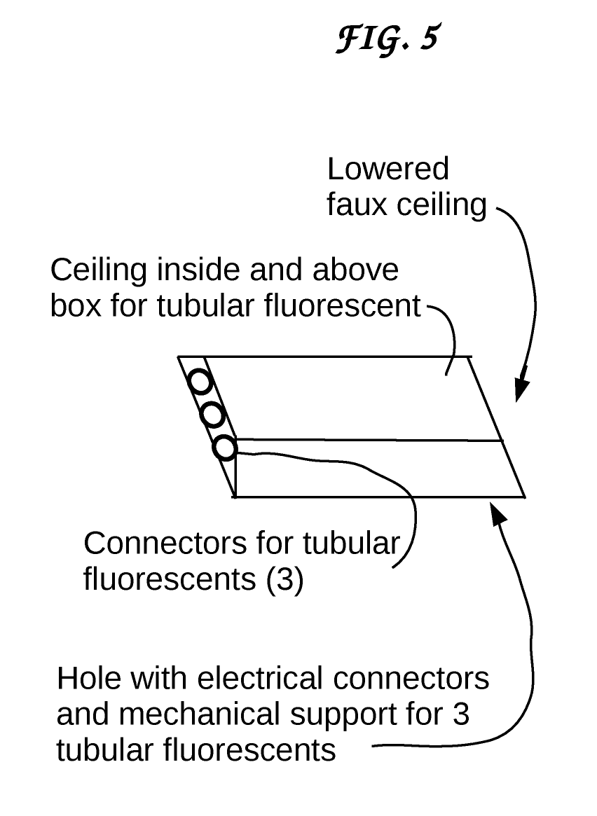

As seen in these figures mentioned above, the main embodiment of our invention discloses a physical support, the drop box, the upper part of which is mechanically and electrically compatible with the standard set by the old tubular fluorescent lamps that are inside a dropped faux-ceiling. The upper part of the drop box of our invention inserts into the hole above the faux-ceiling and the actual ceiling above it, a hole of a depth that is typically, though not necessarily, in the range of 15-20 cm (6 to 8 inches) high, a length slightly longer than the length of the dimension along the tubular fluorescent it is made to hold, say, 4 ft, 6 ft, etc., and a width slightly wider than the width of the few tubular fluorescents it is designed to hold, typically from 2 to 5 lamps, though not necessarily always in this range. The hole above the faux-ceiling where the drop box of our invention is inserted is shown at FIG. 5. The dimensions of the drop box of our invention are then slightly less in length and width than the dimensions of the hole in the faux-ceiling where the drop box is inserted, the dimensions being smaller exactly to allow for the insertion of the drop box in the hole. As seen in the drawing above, the upper part of the drop box of our invention is designed to be inserted in the hole above the faux-ceiling, with some mechanical support (not shown), as a number of screws, of a number of cables, or any other means that is capable of keeping the upper part of the drop box fixed in place. The upper part of the drop box has also the hardware compatible with the standard socket or holder for the tubular fluorescents (older luminaries), which is inserted in the existing electrical hardware from which power is drawn for the electrical power needs of our invention. Any of the common support or fasteners are compatible with our invention, as screwing the upper part to a part of the building structure, or a velcro fastener, or an insertable plug with a holding bar across it to prevent it from falling, or any other type of fastener known to the persons familiar with the mechanical means to keep parts together. It is also possible to use the standard holder for the tubular fluorescents as mechanical support for the drop box of our invention, if the electrical codes of the community where it is installed allows for it, in which case the extra mechanical support is not required. It is also included in our invention a mechanical fastener to fixed parts of the building structure, capable to keep the upper part of the device of our invention in fixed position with respect to the building. FIGS. 3 and 4 show the LED box of our invention with the parts of it marked as above and below the faux-ceiling.

As seen in the figures, the drop box of our invention is higher than the hole above the faux-ceiling into which it is inserted, the extra length protruding below the faux-ceiling, a characteristic that is crucial for the working of our invention. As seen in the figures mentioned above, this lower part of the drop box of our invention is populated with LEDs that are fastened to the lower part of the drop box in such a way as to emit light in a direction perpendicular to the side surfaces of the drop box of our invention, that is, horizontally, or, in some variations, at a small angle above the horizontal, or below the horizontal, or at a “sideways” angle, that is, an angle with the normal to the surface which is at the horizontal direction. This latter case functions to prevent that the light emitted by the LEDs be intercepted by adjoining drop boxes. Of course that these deviations in the directions that the LEDs emit light is not necessary for our invention to operate, but only variations that may or may not be implemented, which may have advantage in some situations.

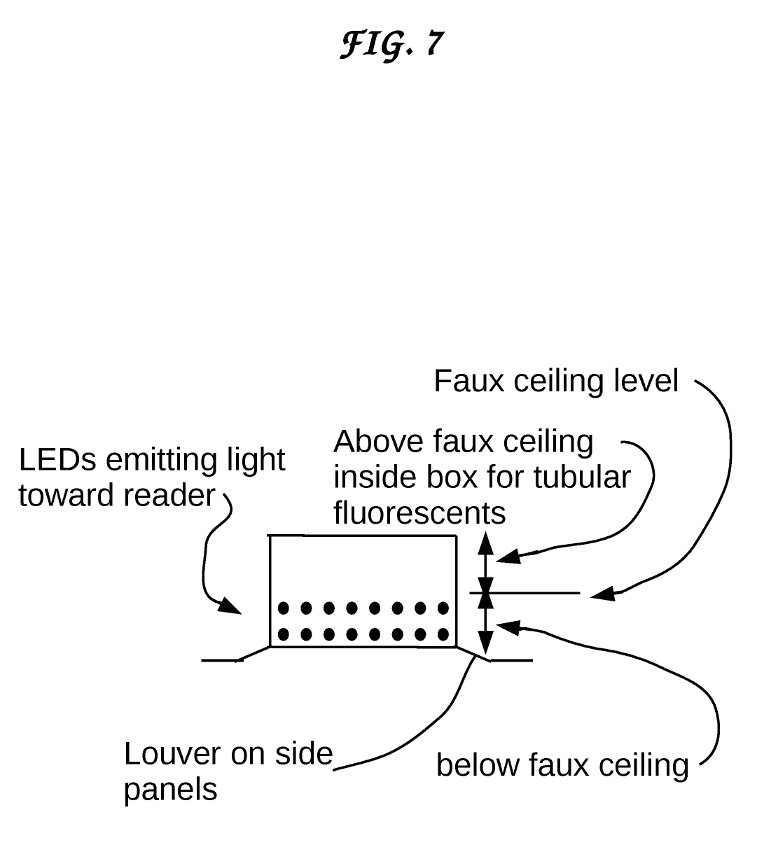

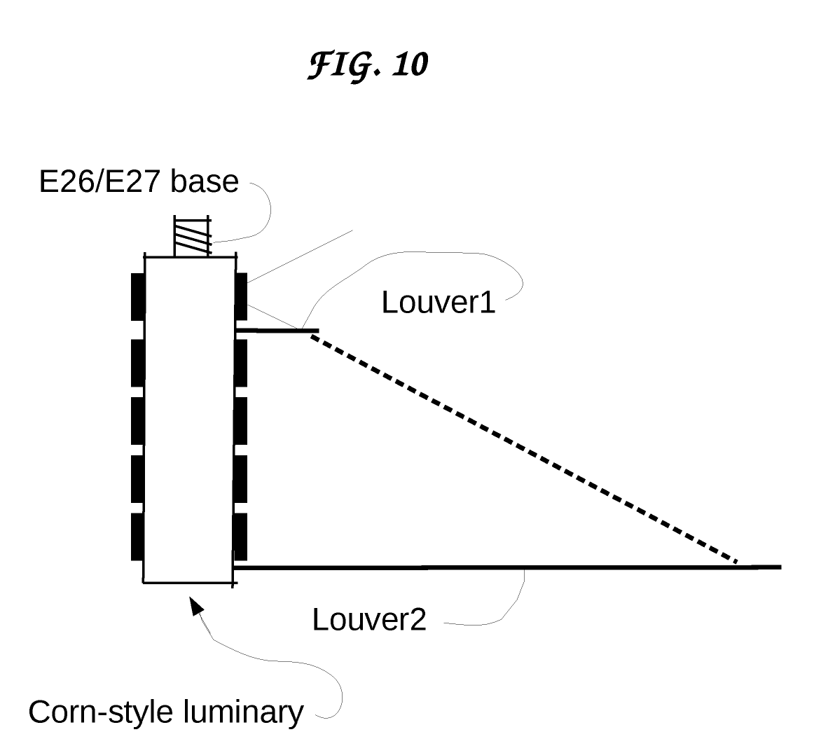

FIG. 7 shows another improvement that is intended to be part of our invention, which is the addition of louvers around the drop box of our invention which are intended to further block light from going into directions where it may be seen by people in the room. For simplicity no louver is shown facing the reader in the figure, though louvers are intended to be all around the drop box of our invention, unless they are unnecessary for a particular case, in which louvers may be absent. FIG. 7 also shows the part of the drop box that are above and below the faux-ceiling, and the hole into which the drop box is inserted. It is to be added that due to the light emission characteristic of the LEDs, which emit light with decreasing power at higher angles with the forward direction, there is no need to block all the light emitted by the LEDs, because the light emitted at higher angles with the forward direction are less bright and so it may be tolerable to allow light directly into the eyes of people that are emitted at high enough angle with the forward direction, so the louver may have a short length. The figure shows a louver with two surfaces, but the louver may have three surfaces (not shown), or one surface (not shown), etc. The location of the louvers with respect to the LED elements matters too, as shown at FIG. 10, where the reader can see that the louver needs to extend further out from the luminary (longer louver) if it is farther from the light origin or LED element. In FIG. 10 the reader can see that louver1, near the LED, may be shorter than louver2, further out from the LED, to block light at the same propagation direction.

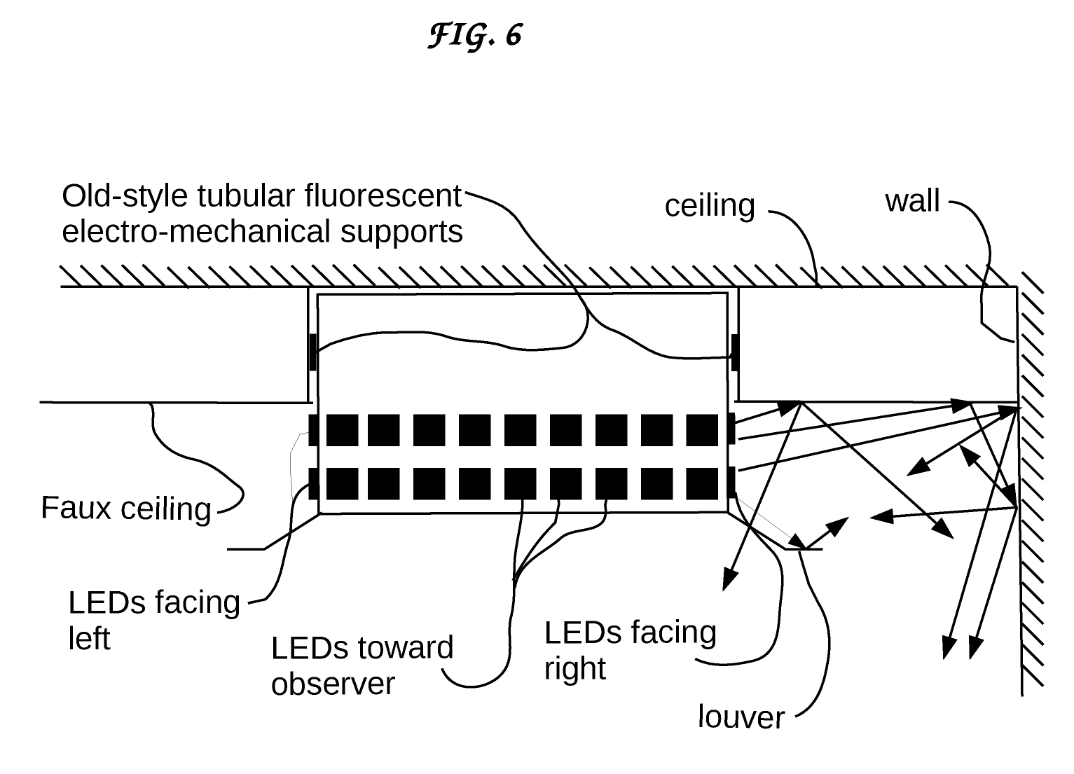

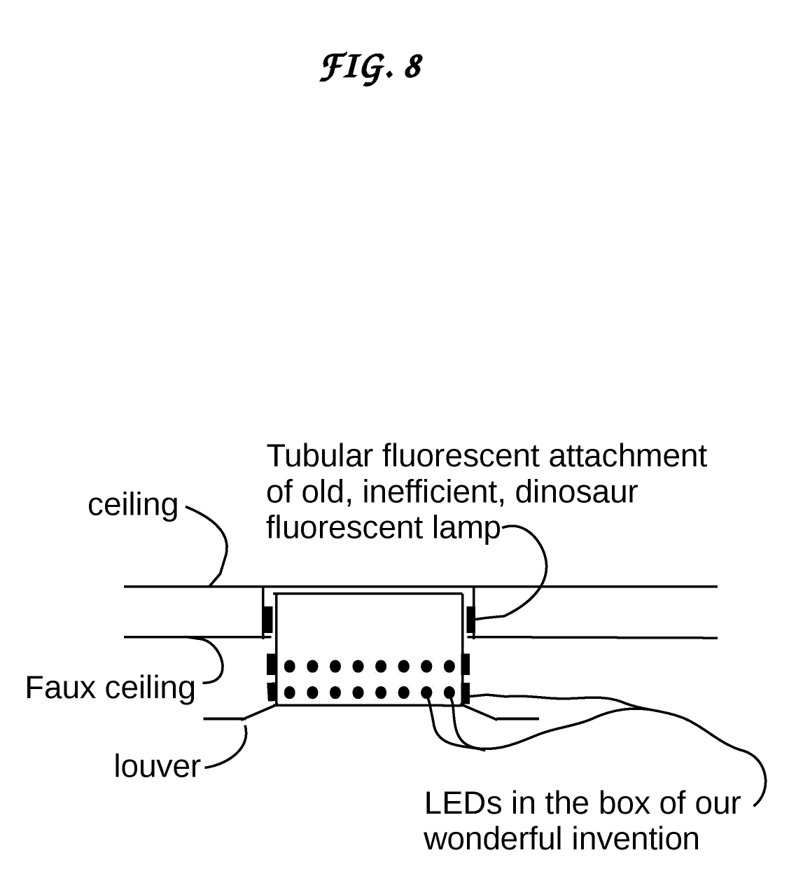

FIGS. 6 and 8 show side views of the drop box of our invention along the long side of it, which is the side along the length of the former tubular fluorescent. In both these figures the reader can see the box inserted in the existing hole above the faux-ceiling, and at FIG. 6 the reader can also see a few “light rays” toward the ceiling and the higher parts of the walls surrounding the drop box. These figures also include a possible louver at the bottom of the drop box to further block light from propagating into the eyes of people below in the room, which is a possible addition to the drop box of our invention to further improve the blocking of bright light directly into the eyes of the people in the room. As the reader can see, the invention is capable to used as a retrofit in an existing luminaire without the need to make modifications to the existing faux ceiling of the exiting old luminaire. These figures show examples of this for the tubular fluorescent lamps but similar retrofits are possible to be used with incandescent bulbs inside an equivalent hole above the faux-ceiling, which, for the case of incandescent bulbs is typically a cylindrical cavity above the faux ceiling, as opposed to a parallelepiped shape hole used for tubular fluorescent lamps. The invention is intended to be used with any shape of hole above the faux ceiling.

Our invention also includes the possible electronics necessary for the DC low-voltage LED to function with the AC higher voltage electrical mains from which our invention draws the electrical power, though the LEDs may also be connected in series for a higher electric potential too or the electronics may be a current limiter or a current source. Neither the physical standard, which is the same as the traditional one tubular fluorescents, nor the electronics, to modify the electrical characteristics of the electrical mains to the LED requirements, which is the same as used in the existing LED replacements, are part of our invention, which is rather the redirection of the light output from the LEDs and a system to select which LED is to be on and which is to be off.

All these still mimic the old devices, failing to take advantage of the small size of the light emitters to distribute the light to the intended direction.

For the sake of clarity, we can re-state the above description of the main embodiment as follows. Our invention discloses a box, call it drop box, that fits into the parallelepiped-like hole above the faux ceiling which contains the tubular fluorescent lamps, still thick enough that a part of the drop box is below the faux ceiling, as seen in FIGS. 6, 7 and 8. To be more precise, the drop box of this variation is taller than the depth of the parallelepiped shaped volume above the faux-ceiling which contains the tubular fluorescent lamps. This drop box should contain the necessary mechanical attachments to hold the drop box in place, with its upper part inside the hole above the faux-ceiling where the old tubular fluorescents were located, while its lower part protrudes below the level of the faux-ceiling. The drop box contains also the electrical connectors, possibly to the connectors that brings power to the old fluorescents, but not necessarily so. In any case, the electronics that control the fluorescents is different than the electronics that control the LEDs, a detail that can be solved and is not part of this invention. The drop box supports a plurality of LEDs on its part that is below the faux-ceiling. In the main embodiment, that works with the rectangularly shaped fluorescent boxes that are most common in offices and schools these days, the drop box has the same rectangular cross-section as the current holes, except for the necessary mechanical clearances that allow for the LED-box to enter into the existing hole above the level of the faux-ceiling. The box has then the shape of a parallelepiped such that its cross section is the size of the hole above the faux-ceiling. We will call F-face the front face of the drop box, corresponding to the longest side of the hole on the faux-ceiling, S-face the side face of the drop box, corresponding to the small side of the hole on the faux-ceiling, Ttop-face the top side of the drop box, the side that is inserted on the the existing hole on the faux-ceiling, and Tbottom-face the bottom side of the drop box, the side of it that faces the floor. On the part of the drop box that hangs below the faux-ceiling, there are a plurality of LEDs that may be all around, that is, pointing to four directions of the sides of the parallelepiped, along the lower part of the two F-faces and the two S-faces, the part that is below the faux-ceiling, or may be on some of the four faces only. Such a latter type would be useful for a drop box that is near a window, for example, in which case the LEDs that points to the window may be omitted, because the light emitted by them is likely to go out of the window (pun intended). These LEDs point generally on a horizontal direction, with the variations as described in the sequel and for the objectives described with each variations.

It will be obvious to the reader that the part of the drop box that is below the faux-ceiling does not have necessarily to have the same cross section as the hole above it. The hanging box may be larger or smaller than the hole above it, and it may have a different cross section, as a hexagon, a circle, etc. The part of the drop box below the faux-ceiling is the only one that is visible and may have any shape as desirable to agree with other constraints, as decoration, light distribution, etc. For example, if there is a need to have a larger number of LEDs than can fit on the side of a box with the same cross section as the hole above it, there are two possible solutions: one is to have two, three, or more layers of LEDs, the other solution being to have a larger box that offers a larger surface area where to attach LEDs. It will also not escape the reader that the part of the drop box that is above the faux-ceiling may not be a box at all, because all that is required for the upper part of the drop box is that it provides a mechanical support for the box below it and that it provides the necessary electrical connection to bring electrical power to the LEDs at the surface of the drop box.

It is also possible to have LED light emitting elements or devices on the lower surface of the lower part. In this case these LED light emitting elements may emit light directly into the eyes of people in the room, which is undesirable, so the invention discloses the existence of a frosty surface to cover the light path of these possible LEDs on the lower surface of the lower part, to scatter the light and make the luminance (or brightness in common language) of the lower part acceptable to people in the room.

### Operation of Invention

The objective of artificial illumination is, in the majority of cases, to spread the light in such a way that the full room is diffused with an even illumination reaching everywhere in equal intensity from all directions. Our invention operates on the fact that the LED light emitting elements of the LED light substitutes for all the existing technologies are all small in size (a few square mm) and all emit on a narrow cone of light (though not as narrow as a laser diode!). The operation of our invention is then to locate the LEDs in such positions and along such directions that they point toward a nearby white surface (higher reflectivity and small absorptivity and transmissivity), from which light is scattered at all angles towards the space which is to receive illumination. A second operational goal of the invention is to avoid direct light from the LED emitters into the eyes of the humans in the environment, because the LED beam is generally brighter than comfortable for direct view. Another important point of the operation of the invention is the invention is the directional characteristic of the light emitted by the LED; indeed, this is important for the operation of the invention, which depends on directing the light emanating from the light sources to the higher parts of the walls, to the ceiling, and to other parts from where the light is scattered to the full volume of the room.

Note that the LEDs should emit the light towards surfaces that are diffuse reflectors, as opposed to specular reflectors. The reason for this being that if the LED light hits a specular reflecting surface, particularly on the first surface, the beam would continue to be too bright for direct interception by human eyes.

In the following paragraph, and throughout this patent specification, by “higher parts of the walls” or any variation of these words, we mean the higher 1% of the walls, or perhaps more, the higher 10% of the walls, or even more, the higher 30% of the walls, or even the higher 50% or more, all depending on the height of the room. Generally we mean “higher parts of the walls” to be high enough on the walls as to be above the eye level of a normal tall human, not necessarily a tall basketball player nor a giant. So, given the height of a ceiling, the fraction that lies above 180 cm (5 ft 11 in) is higher the taller is the ceiling, 180 cm being the eye level of a tall person. For an average 3 m tall ceiling, characteristic of a new building, “higher part of the wall” mean (3.0−1.8)/3.0=0.4=40%, so for this case in general higher parts of the walls means the highest 40% of the wall.

FIG. 6 depicts the operation of the invention, which is the light emission from LEDs directed to the higher parts of the walls or to the ceiling, as indicated by the LED emitters at the right of the figure. At this figure, the arrows emanating from the LEDs facing the right represent light rays. Given the location and direction of the LED emitters, as seen, and that LED emitters emit light on a narrow cone of light, most of the light energy emitted by these LEDs are sure to hit either the higher part of the walls or to hit the ceiling, from where the light is reflected in a diffuse way—we are assuming that the walls are diffuse reflectors that also have high reflectivity, a condition met by most of the paintings used on walls and ceilings. With “light on a narrow cone” we mean that 37% of the light is emitted on this narrow cone, and the value 37% being the generally accepted convention applied to quantities that never go to zero but keep instead decreasing monotonically, that when the quantity reaches the value 1/e=1/2.71828=0.37 then the quantity is assumed to have decreased to zero. In the simplest case the drop box shown is populated with LEDs on all four sides, which means that all the four walls around are illuminated by the LEDs, and the ceiling as well. This light is then reflected to all directions of the room, creating a soft light that is averaged on all, or mostly all, points in the room. The full wall and ceiling are then the source of most of the light in the room, so the luminance (or brightness in common language) is even lower than the luminance from an equivalent luminary covered by a frosty glass or plastic, all the while the wall reflection is of the order of 0.9 (90% of the light is reflected, 10% of the light is absorbed by the paint), which compares positively with a 75% or less transmissivity of the typical frosty surface currently used for the scattering surfaces that surround a luminary inside it, with the objective of decreasing the source's luminance (the brightness of the source in common language). Repeating, for the average situation in a typical room, our invention allows 90% of the light energy to illuminate the room (10% loss due to paint absorption), while the currently devices, using a frosty surface surrounding the luminary only allows 75% of the light energy to illuminate the room (25% loss due to absorption by the frosty material).

### Description and Operation of Alternative Embodiments

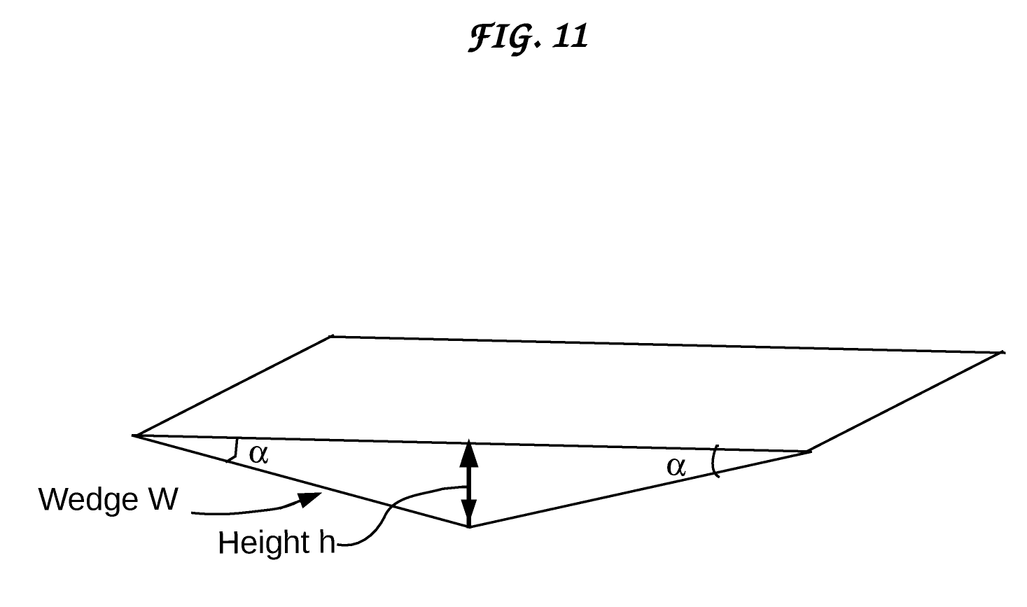

FIG. 11 shows an interesting alternative enhancement to our wonderful invention, which is directed to forestall light being emitted into an adjacent drop box, where it may be absorbed by darker surfaces. FIG. 11 shows a wedge, or a slanted faux ceiling, which drops below the faux ceiling level just enough to block a direct path from any LED at the side of some drop box and any parts of another adjoining drop box. For this objective the height h, which is the vertical distance from the existing faux ceiling level to the lower part of the wedge, should be such that at least a substantial part of the light emitted by the LEDs is reflected downward, instead of propagating into the side of a possible adjoining drop box—if any. As a first approximation one may make h to be equal to the height of the drop box below the previous faux ceiling. This slanted ceiling has also the advantage that is further forces reflected light to be reflected to lower parts of the room, because of the incidence angle, as described by the known Snell's law and Fresnel equations.

We used the tubular fluorescent drop box as the main embodiment, but the inventive method of directing the low-divergence LED light beam toward highly reflective surfaces, as the ceiling and higher sections of the walls, with view of not allowing the light beam to pass through paths which may cross the eyes of people, is perfectly transferable to other light replacements. It is quite possible to use the inventive method with other standards different than the above faux ceiling tubular fluorescents, as with also above faux ceiling either incandescents or halogen luminaries. There are some of these embedded in the ceiling, with sometimes good reflecting white cylindrical walls, sometimes with good reflecting mirror-like walls, and sometimes poorly reflecting black walls. In such a case, where the “box” is cylindrical, an also cylindrical box, similar to the drop box of the main embodiment only with a circular cross section could be used. It is not necessary that the lower part of the drop box, that is, the part below the faux ceiling be cylindrical too; a moment of reflection will show the reader that the lower part of the drop box may have any cross section, including a parallelepiped, hexagonal, etc., with the faces of which drop box populated by LEDs emitting light horizontally towards the walls around. It is also not necessary that the part of the drop box that is inserted into the hole above the faux ceiling be of a cylindrical cross section! After all there is nobody seeing it, and all that is required is that the upper part of the drop box provides a mechanical support capable of holding the lower part of the drop box in a fixed position, and an electrical connection to the building power cables to bring electrical power to the LEDs.

The adaptation to each case is to keep the method of directing the light emitted by the LEDs towards flat surfaces (preferably) and at such light propagation paths that human eyes are not expected to be in the light path, due to the LED high luminance (brightness).

Other variation is the recessed, indirect light, in which case the light element, either filament bulb or fluorescent, is behind a generally light opaque obstruction at the upper edge of the walls, near the ceiling, opening upwards and with the lighting elements behind this opaque obstruction which may carry some ornament for decoration, and with the light elements sending light in all directions around them from the inside of the opaque obstruction at the upper edges of the walls. The LED substitution in this case would be to install LED devices, in the appropriate physical support that is compatible with the one being substituted, and with LED elements so positioned as to emit light slightly upwards, barely above the horizontal direction, light that is then reflected by the ceiling, and to emit light horizontally to the opposite wall, including a small angle below the horizontal, as long as it reaches the opposite wall at a height above 180 cm (5 ft 11), which is above the eyes of most humans. These LEDs may be above the opening of the opaque obstruction around the walls. A moment of reflection will show the reader that this is a variation of the drop box of our invention in which the drop box is tilted sideways, instead of being vertical, keeping the same function of emitting light toward the ceiling and toward the walls.

Another alternative embodiment for our invention is to use detachable strips configured to be fixed at the lower part, the detachable strips having also electrical connectors configured to be attached to mating electrical connectors at the lower part, also having mechanical and electrical connectors for a subset of the LED light emitters attached to the strip. This alternative embodiment discloses a number of attachment positions at the surfaces of the lower part some of which may be left without detachable strips, some of which may be populated with detachable strips. This variation has the advantage that it allows for the avoidance of light being emitted along certain directions, which could be accomplished simply by not attaching strips the LED light emitters of which emit light along the undesirable directions. A case in which this could be advantageous is when a particular drop box happens to be in such a location that certain of the LEDs on its side would emit light toward a window, which would be a light not used to illuminate the room, as intended. Drop boxes that are in such positions could then not be populated with strips that support LED light emitters that emit light toward the window (or other undesirable direction), therefore not emitting light along the window or other undesirable direction. Another possibility would be if a particular direction happened to be a darker wall, of happened to have a darker and large piece of furniture, in which case the reflection from the wall, or from the piece of furniture, would be low, with the consequent less of efficiency, so a lack of emitting LEDs along such directions would be advantageous. The detachable LED strips would be fit with some of the existing means for securing their positions on the lower part of the drop box, as by screws (and possibly nuts), or velcro, or any of the existing technologies to fasten one device on the other. The detachable LED strips would also be fit with one of the existing electrical connector standards to connect the LED strips to the lower part of the drop box, as any of the existing electrical connectors used in electronics.

### CONCLUSION, RAMIFICATIONS, AND SCOPE OF INVENTION

There are several other variations and additions to the main embodiment. For example, it is possible to put lenses at the front of the LEDs to increase the beam divergence, which ultimately increases the illumination evenness. Such lenses may be either circular or cylindrical, the latter case more adapted to the LED replacement to the tubular fluorescent lamps but works also for even a single LED because it may be the case the it is useful to increase divergence along one direction only, which requires a cylindrical lens. These lenses may be made from plastic molded into the LED case or they may be common lenses added to the device. These lenses may be individual, one for each LED or they may be for more than one LED, or for all the LEDs. These lenses may also be non-isotropic, even if this is a most unusual feature. In this case the anisotropy would be to cause beam divergence for the part of the light that happens to be propagating upwards (where there would be a cylindrical curvature), all the while causing no beam divergence on the part of the light that propagates downwards (where there would be no curvature and therefore no beam spreading). The non-isotropy would be a good feature because it would be advantageous to spread the light beam that is propagating upwards, as long as it is not so spread as to be diverted down, towards possible human eyes, while it would be disadvantageous to spread the light beam that is propagating downwards, because this would redirect some light further downwards, towards human eyes who would be inconvenienced by the bright light. Another possibility would be an even more unusual cylindrical lens one which is so curved as to cause beam divergence on its upper part, causing beam divergence for the upwards propagating light, while its lower part would be so curved as to redirect the incoming light towards the ceiling, to avoid direct bright light into human eyes.

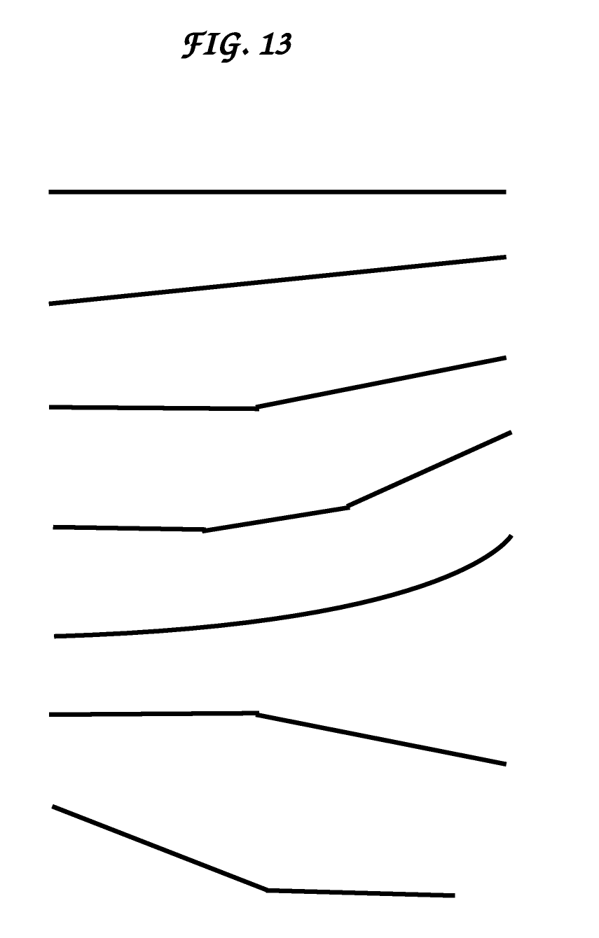

It is also possible to have fins, or louvers, or shutters below the LEDs, which are positioned in such a manner as to block the light propagation downwards along directions and at such angles with the horizontal to prevent human eyes receiving the direct light beam causing discomfort on them. These fins should preferentially be mirror-like, redirecting as much as technically possible of the light towards the ceiling or some other reflecting surface, therefore contributing for the total illumination of the room. Still it is quite possible to have the fins made from milky glass, instead of a reflecting surface, because given that the geometry ensures a grazing angle of incidence and that Maxwell's equations and Fresnel's equations tells us that the reflectivity is a function of the angle of incidence, going to 100% as the angle of incidence approaches zero (the angle is traditionally measured from the normal direction, so zero degrees means grazing incidence). These fins may be flat or they may also be curved of faceted, as seen in FIG. 13. The fins may also have a corrugated surface which would reflect the light towards different directions, increasing the evenness of the light distribution in the room. The louvers themselves may be of many shapes, some examples of which are seen in FIG. 13. The louvers may be at the lowest LED, as seen in the figures, but they may be underneath each LED too. Our figures show the louvers at the lowest position only for simplicity but we do not intend to say that this is the only option.

It is also possible to have small swiveling mirrors in front of each LED, or in front of a subset of the LEDs, which are capable of redirecting the emitted light into a range of new directions, out from the initial propagation direction. Possible positioning of the mirrors are: (a) the mirror out of the way, with no effect, (b) the mirror partly in, redirecting part of the light beam, and (c) the mirror all the way in the light beam, redirecting most of the beam out of the original direction. Therefore a swiveling mirror offers several possibilities. For example, what may be the best option is to have the swiveling mirror occupying the position of a louver below the LED with the swiveling axis at one of the edges of the mirror. This option has the mirror in such a position that in its neutral position the mirror acts as a louver as described above. As the mirror is tilted, it will block more and more of the emitted light, at the same time that it reflects it to larger and larger angles, until finally the mirror is so tilted that it completely blocks the initial light, reflecting all of it to another direction. This other direction may be just a few degrees, if the mirror is long enough, or may be 45 degrees, if the length of the mirror is only equal to sqrt(2)/2 times the beam's diameter d (that is, 0.707*d), in which case beam will block the beam when it is at 45 dgs. It is possible to use smaller mirrors but though this is possible this is not advisable because if the beam is smaller than 0.707*d then the beam would have to go at an angle larger than 45 dgs. and would start redirecting the light backwards, though it is still possible to use such smaller mirrors.

### More Ramifications, Dropped Box from Fluorescents, Incandescents, Halogens, Etc.

These ramifications and variations are applicable to most, if not all types of luminaries. We used the particular case of the tubular fluorescent luminaries, of the type common in business and schools, as the main embodiment, just to present one preferred embodiment, but the reader will recognize that the same principles apply to other types of luminaries with small adaptations, as for similarly embedded incandescents and halogen lamps, to mention just two cases.

The LED-box is preferably constructed of two adjoining parts, an upper part and a lower parts, approximately of the sizes of the space above and below the faux-ceiling. There are appropriate fastening devices (not shown) that keeps the lower part fastened to the upper part, and the upper part is provided with mechanical fasteners that attaches it to the ceiling or other appropriate fixed points on the building structure (also not shown). This is preferable than a single unit because it may facilitate the attachment of LED-box to the ceiling, as a technician would have access, through the lower hole in the upper part of LED-box to secure the upper part of LED-box to the building structure, than latter the lower part of LED-box could be secured to a hanging lower edge of the upper part of LED-box. This split of the LED-box in two parts is not necessary for the invention, but only an enhancement to make it easier to install, which in no way limits the generality of the LED-box. Another variations is for a unit fixed to a wall of the building, in which case the upper part is fixed not at its upper part to the ceiling but is fixed instead at one or more of its sides to a wall of the building or to some other fixed point laterally positioned with respect to the invention.

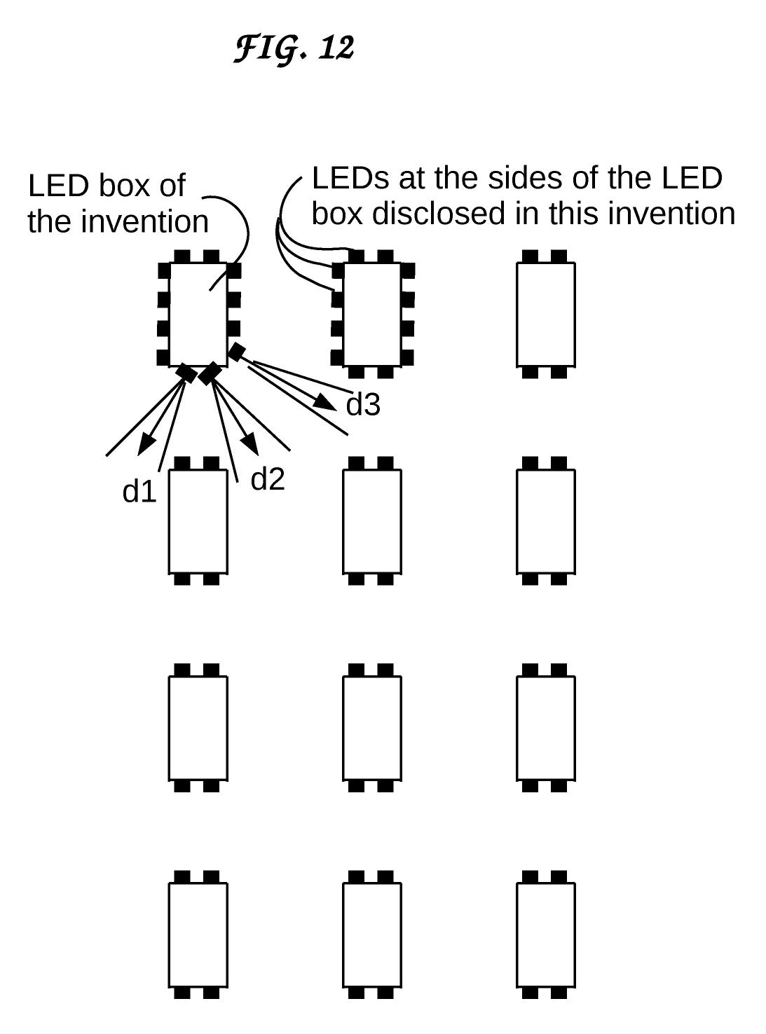

Due to the geometry of the device, such LEDs emit light substantially horizontal, though with the natural angular divergence of the LEDs as shown in the FIG. 12. Consequently some of the emitted light points slightly upwards, some straight horizontally, some slightly downwards, some to the left, some to the right, the four deviations from the horizontal corresponding to the angular aperture of the light emitted by the LEDs, which are emitted out of the LED chip as a conical volume. The fraction of “light rays” (there is no such a thing as a light ray, but we are here using the widely accepted word to convey the point) that is emitted downwards might, under certain geometries, point directly into people's eyes, so the invention also discloses a louver (see FIGS. 6, 7 and 8) which reflects the downwards pointing light rays either upwards or to a more horizontal direction, or to another direction that is slightly above the original direction. There are many sizes and shapes for the louvers which are contemplated for this feature, some of which are shown in FIG. 13, but these examples of louvers is not intended to be exhaustive, an infinite variation of them being possible, in length and shape, and covered by this patent application.

As the exception pointed out above regarding the horizontal alignment of the LEDs, the LEDs attached to the LED-box of the invention may be positioned such that they point to a direction deviating by an angle beta from the normal (perpendicular) to the LED-box surface, this angle beta being generally on a horizontal plane but also possibly on a vertical direction. This way the LEDs still point horizontally (or at an angle with the horizontal plane), but no longer normal to the F-face or S-face. Such a deviation from the normal direction may be preferred to forestall that the light is emitted directly towards the LED-boxes that surround any of them, because the light that hits the neighboring LED-boxes has a non-zero probability of being absorbed, which in turn decreases the efficiency of the device. This is shown in FIG. 12. It is also possible to point the LEDs somewhat higher, in which case the angle beta would be not to the left or to the right, as discussed above, but the angle beta would be upwards. This could be done, for example, to decrease the fraction of the light emitted downwards, which could be advantageous because this is light that is generally to be avoided because it could hit people's eyes in the room. In this case, of a vertically upwards beta deviation of the LEDs, there would be more light reflected from the ceiling.

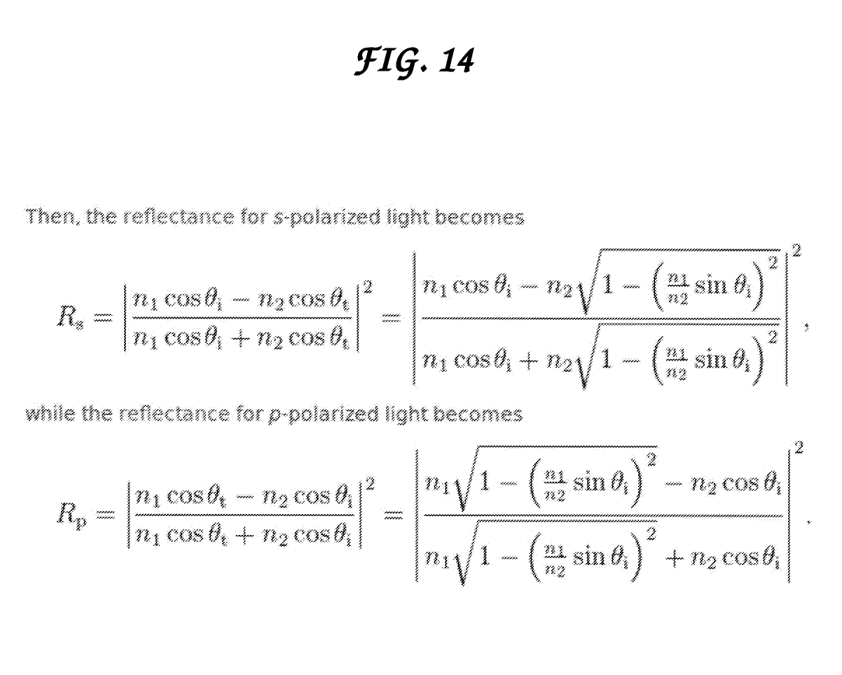

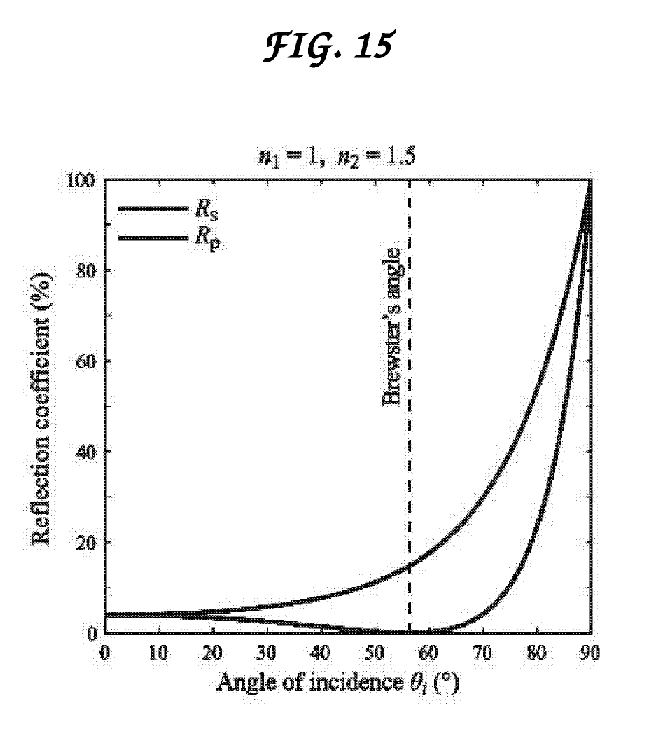

This invention also discloses a wedge W, as seen in FIG. 11, which interposes a slanted surface between any two LED-box as shown. Because of the geometry and position of the LEDs and the wedge W, the angle of incidence of the light emanating from the LEDs if they happen to be intercepted by the wedge W, is almost 90 degrees, say, 87 degrees, or 85 degrees. This large angle is important for the invention because the Fresnel equations (FIGS. 14 and 15) show that the reflection probability is high, close to 1 (that is, close to 100%), for such angles of incidence as 90 degrees minus epsilon, where epsilon is a small angle. The slanted surface is attached to the ceiling at its larger surface, which is at the top if the figure. The smaller surfaces drop below the faux-ceiling such a distance that no LED in any of the LED-box has a direct sight to the neighboring LED-boxes. This causes that the light that would be otherwise emitted towards any of the neighboring LED-boxes is instead scattered by the slanted surface. If height h of wedge W were equal to or larger than the distance from the faux-ceiling to the lower edge of LED-box then there would be no light emitted from one LED-box towards another LED-box, which is advantageous because such emission would cause some undesirable light absorption.

As a way of clarification, our invention discloses a device that is able to eliminate the common frosty scattering element surrounding the luminary, introducing instead a plurality of LED luminaries that are so positioned as to direct the light produced by them to such surfaces that it is not expected that human eyes should intercept the light emitted by the LEDs before the first scattering surface. In this case, when the LEDs are high, near the ceiling, the LED light is emitted towards either the ceiling or the upper part of the surrounding walls, from where it scatters into the the full room (ceiling, walls around the room and floor), preventing human eyes to be exposed to the direct brightness of the light sources.

We disclosed a particular geometry adapted for the tubular fluorescents, but the reader will see that the same principles apply to other light sources, as incandescents, halogen, etc., so we do not want to limit our invention to apply to tubular fluorescent lamps. For example, embedded incandescents and halogens (that is, above a faux-ceiling) usually are in a cylindrical hole, instead of a hole in the shape of a parallelepiped as is the case of fluorescents, but the shape of the upper part does not change the invention. It is our intention to apply the LED drop box to any luminary that is embedded in a faux-ceiling or similar configurations or also when a drop box can be attached to an ordinary ceiling. This variation is a luminary that is on the outer surfaces of a box that hangs from the ceiling, in which case everything is the same as in the preferred embodiment except that the LED-box is completely hanging from the ceiling, instead of being partly embedded into the ceiling. Another example of a similar configuration is a luminary that is part of an indirect lighting system (usually inside an opaque barrier around the upper part of the wall). It is our intention that any variation that maintains the principles disclosed in the preferred embodiment is still protected by the disclosure.

1. A device for electric light illumination for a room with a ceiling above the room and walls around the room, for providing directional lighting and configured for electromechanical connection to a fixed part of the room with mechanical and electrical power connection, with an upper part attached to a fixed point of a building and connected to building electrical power wires, and configured for providing first physical support with mechanical and electrical connections to a lower part, the lower part providing mechanical and electrical connections to a plurality of LED light emitters, the illumination device comprising:
the upper part, the lower part, and the plurality of LED light emitters, the upper part configured to make mechanical supporting connection to a fixed location in the room and electrical connection to the building electrical power wires, capable of providing electrical power for the LED light emitters, the lower part fixed in place to the upper part, receiving electrical power from a connection to the upper part, and configured to provide fixed support and electrical power connection for the plurality of LEDs,
wherein the lower part of the device for electric light illumination is configured with surfaces such that the normal to the surfaces of the lower part are lines the directions of which are within cones of apex angle less than 30 degrees deviation from a horizontal direction with the apex of the cone at the LED light emitters,
wherein the plurality of LED light emitters affixed on the lower part of the device emit light on a cone of light facing the upper part of the walls and the ceiling of the room.

2. The device for electric light illumination of claim 1 wherein louvers extend from beneath the LEDs at the lower part of the device to further direct light toward the ceiling and the upper parts of the walls.

3. The device for electric light illumination of claim 1 wherein the plurality of LEDs are mounted on a plurality of detachable strips with a plurality of LED light emitters on each detachable strip,
wherein the lower part of the device and the detachable strips have the necessary mechanical means to keep the detachable strips fixed on the lower part of the device, and the necessary electrical connectors to electrically connect the strips to the lower part of the device,

4. The device for electric light illumination of claim 1 wherein the device is a substitution for older luminary inside a hole above a faux ceiling,
wherein there are mechanical support structure connected to the building to keep the upper part in a fixed position with respect to the building, and electrical socket connectors capable for connection to the upper part capable of providing electric power to the upper part inside the hole above the faux ceiling,
wherein the upper part of our invention is inserted inside the hole above the faux ceiling with mechanical fasteners to fixed parts of the building structure and electrical connection to the electrical sockets of the older luminary inside the hole above the faux ceiling.

5. The device for electric light illumination of claim 4 wherein the older luminaries inside the hole above the faux ceiling are tubular fluorescent lights.

6. The device for electric light illumination of claim 4 wherein the older luminary inside the hole above the faux ceiling is an incandescent bulb light.

7. A method for illumination of a room of a building, the room having walls around the room, a floor below the room and a ceiling above the room, the method comprising:
an upper supporting structure mechanically connected to a fixed place of the room, such that there is also electrical power wire connections from the building to the upper supporting structure that is capable of providing electrical power to the upper supporting structure;
a lower supporting structure mechanically connected in a fixed position to the upper supporting structure, wherein the lower supporting structure also has electrical conductive wires connected to the upper supporting structure, designed to transfer electrical power from the upper supporting structure to the lower supporting structure, the lower supporting structure also having a plurality of electromechanical connectors for a plurality of LED light emitting elements to be attached to the surfaces of the lower supporting structure;
a plurality of LED light emitting elements mechanically and electrically connected to the lower supporting structure with mechanical connections to keep the LED light emitting elements in fixed position with respect to the lower supporting structure, also receiving electrical power for each LED light emitting element;
wherein in use the LED light emitting devices emit light toward the upper part of the walls and of the ceiling of the room.

8. The method of claim 7 wherein the upper supporting structure lies inside a recessed cavity of an existing luminaire on the ceiling or on the walls of the room.

9. The method of claim 7 wherein the lower supporting structure is a box attached to the upper supporting structure, the lower supporting structure having an upper face and a lower face and side faces, wherein the LED light emitters are attached to the side faces of the lower supporting structure.

10. The method of claim 9 with further LED light emitters located at the lower face of the lower supporting structure.

11. The method of claim 7 with further louvers under the LED light emitters.

12. The method of claim 7 with further strips, each strip capable of supporting a subset of LED light emitters, the strips to support the subset of LED light emitters comprising:
a supporting structure with mechanical fasteners to physically keep the strips that support the LED light emitter in fixed position relative to the lower part, with further electrical connections that allow the strips that support the LED light emitter to receive electric power from the lower part, wherein
subsets of the LED light emitters may be attached to the strips in fixed position with respect to the strips and receiving electric power from the strips, wherein
the LED light emitters are so positioned on the strips as to emit light centered on a direction that is less than 30 degrees below a horizontal line passing through the LED light emitters.

13. An illumination apparatus for illuminating a room with a floor below the room, a ceiling above the room and walls around the room between the floor and the ceiling, the illumination apparatus comprising:
a supporting upper part configured to be in fixed position with respect to the room and to receive electric power from wires connected to the room;
a supporting lower part configured to be in fixed position with respect to the upper part and to receive electric power from wires connected to the upper part;
a plurality of LED light emitters configured to be in fixed position with respect to the lower part and to receive electric power from the lower part;
means for mechanically attaching the upper part to a fixed point in the room, for mechanically attaching the lower part to the upper part, and for mechanically attaching the LED light emitters to the lower part,
physically connecting the room, the upper part, the lower part and the LED light emitters together,
while providing electric power connection from the room to the upper part, from the upper part to the lower part and from the lower part to the LED light emitters,
electrically connecting the room, the upper part, the lower part and the LED light emitters together,
whereas the LED light emitters produce directional light toward the upper part of the walls of the room.

14. The illumination apparatus of claim 13 wherein the upper part lies inside a recessed cavity of an existing luminaire on the ceiling or on the walls of the room.

15. The illumination apparatus of claim 14 wherein the recessed cavity of the existing luminaire on the ceiling or on the walls of the room is configured to receive tubular fluorescent lights.

16. The illumination apparatus of claim 13 wherein the lower part is a box with an upper face toward to the upper part and a lower face and side faces, wherein the LED light emitters are attached to the side faces of the lower part.

17. The illumination apparatus of claim 16 with further LED light emitters located at the lower face of the lower part.

18. The illumination apparatus of claim 13 with further louvers under the LED light emitters.

19. The illumination apparatus of claim 13 with further electro-mechanical supporting strips, wherein,
each electro-mechanical supporting strip is adapted for supporting a subset of LED light emitters, the electro-mechanical supporting strips adapted for supporting the subset of LED light emitters comprising:
a supporting structure with mechanical fasteners for mechanically keeping the electro-mechanical supporting strips that support the LED light emitter in fixed position relative to the lower part, with further electrical connections that allow the electro-mechanical supporting strips that support the LED light emitter to receive electric power from the lower part, wherein
the electro-mechanical supporting strips may be electively attached to selected parts of the lower part, wherein
the LED light emitters are so positioned on the electro-mechanical supporting strips as to emit light centered on a direction that deviates less than 30 degrees within a cone with apex at the LED light emitter and axis along a horizontal line passing through the LED light emitter,
